(19) United States
(12) Patent Application Publication
(10) Pub. No.: US 2003/0053532 A1
(43) Pub. Date: Mar. 20, 2003

(54) Displaying modulation errors for OFDM signals

(76) Inventors: Robert T. Cutler, Everett, WA (US); Michael L. Hall, Marysville, WA (US); Eric J. Backus, Bothell, WA (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 09/957,298

(22) Filed: Sep. 19, 2001

(51) Int. Cl. H04Q 1/20; H04B 3/46; H04B 17/00

(52) U.S. Cl. 375/224

(57) ABSTRACT

Error display in a multiple carrier modulation format. In a multiple carrier modulation format such as OFDM, displaying error spectrum plots and error time plots. The error spectrum plot shows a set of bar graphs arranged by carrier, each bar graph showing error points for that carrier collected over a plurality of symbol times. The error time plot shows errors over all carriers plotted as a symbol time series. Average errors in both plots may be indicated, and connected to show trends.

### BACKGROUND OF THE INVENTION

1. Field of the Invention

The invention pertains to the field of signal analyzers, more particularly to signal analyzers dealing with multiple carrier signaling systems such as OFDM.

2. Art Background

Modulation is the art of impressing intelligence on a signal. Demodulation is the extraction of intelligence from a signal. In systems such as QPSK, a single carrier signal is used, and is modulated in amplitude and phase. Systems such as OFDM, Orthogonal Frequency Domain Modulation, use multiple carriers in parallel, spaced such that these subcarriers do not cause inter-carrier interference. Each subcarrier is modulated in amplitude and phase. For example, IEEE standard 802.11a OFDM uses 52 subcarriers equally spaced around a center frequency.

The performance of systems built with actual components often differs from the modeled ideal. It is the task of test equipment manufacturers to produce equipment which assists the designers and maintainers of systems to understand and measure just how their implementations differ from the ideal, and to measure and identify these errors.

For example, OFDM systems require modulation and transmission systems with linearity and low phase noise. The presence of nonlinearities and noise within these system introduce errors into the signals.

Existing test systems allow the measurement and display of parameters such as error vector magnitude of OFDM signals. Typically, the displayed error vector magnitude is computed over all subcarriers used in the system, and displayed as a single value.

Existing test equipment, such as the Rohde & Schwartz EFA DVB-T OFDM Analyzer, and the Agilent Technologies E9285A DVB-T COFDM Analyzer, allow the display of OFDM signals and characteristics such as error vector magnitude. Neither of these systems, however, allows for the determination of the spatial characteristics of modulation errors over time, that is, the error distribution as functions of frequency and of time, and by symbol.

### SUMMARY OF THE INVENTION

Modulation errors in multi-carrier systems such as OFDM are displayed. In an error vector spectrum plot, the x-axis is the subcarrier frequency or subcarrier number, and the y-axis is the magnitude of the error. The RMS of the errors as a function of subcarrier (frequency) is plotted over the individual points. In an error vector time plot, the x-axis is now time and the RMS line is now an RMS over all carriers at each point in time. At each symbol time, the magnitude of the error is plotted for all carriers as the y-axis.

### BRIEF DESCRIPTION OF THE DRAWINGS

The present invention is described with respect to particular exemplary embodiments thereof and reference is made to the drawings in which:

FIG. 1 is a block diagram of a portion of an OFDM receiver,

FIG. 2 shows the screen display from a Rohde & Schwartz EFA DVB-T OFDM Analyzer,

FIG. 3 shows the screen display from an Agilent Technologies E9285A DVB-T COFDM Analyzer, and

FIG. 4 shows a display according to the present invention.

### DETAILED DESCRIPTION

Multi-carrier digital transmission systems such as OFDM, IEEE Standard 802.11a, are known to the art. IEEE 802.11a OFDM, Orthogonal Frequency Domain Modulation, uses multiple subcarriers in parallel, spaced such that the subcarriers do not cause inter-carrier interference. Each subcarrier is modulated in amplitude and phase to transmit a symbol. IEEE standard 802.11a OFDM uses 52 subcarriers equally spaced around a center frequency. While the present invention is explained in terms of a particular OFDM system, IEEE 802.11a, it is equally applicable to other OFDM systems including but not limited to DVB-T (ETSI 300 744), DAB digital audio broadcast, HiperLan/2, COFDM, and ISDB-T.

802.11a systems dedicate a group of subcarriers, known as pilot carriers, which contain known symbols.

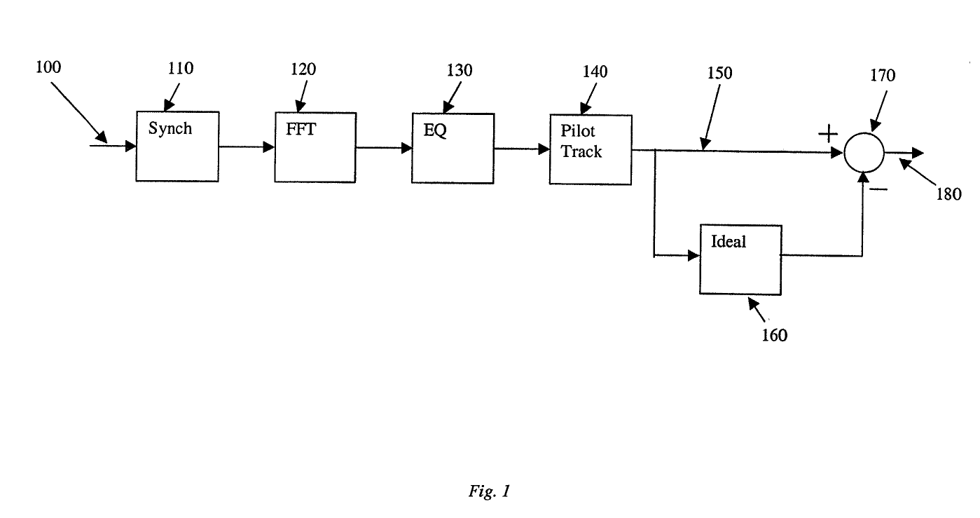

The reception process, as known to the art, is shown in FIG. 1. The signal processing shown in FIG. 1 is typically performed in the digital domain, using digital signal processors (DSPs) or high speed general purpose processors. A digitized OFDM signal is present at input 100. The digitized signal is first synchronized, 110. Then an M-point fast Fourier transform (FFT) is calculated, 120, where M is a power of two greater than or equal to the number of carriers present. The result of the FFT is a complex data point for each subcarrier (x+iy), representing the state of that subcarrier. The next step in the process is equalization, 130, where systemic errors such as those introduced by multipath distortion are corrected. This is typically accomplished by a single complex multiplication on each subcarrier.

Pilot tracking, 140, is performed to eliminate errors such as short-term phase noise. Since the symbols on the pilot carriers are known, the aggregate errors over all pilot carriers may be used to remove errors common to all subcarriers, even though the symbol contents of the non-pilot subcarriers are not known.

The output 150 of the pilot tracking stage contains demodulated corrected symbols in the form of complex data points (x+iy) for each of the m subcarriers used in the system. Modulation of each subcarrier typically sets the subcarrier to a particular point on a complex circle. Systems such as BPSK and QPSK normalize points to an RMS level of one, where systems such as 16 QAM and 64 QAM are more complex. Real world design and performance limitations render these demodulated points close to the ideal values.

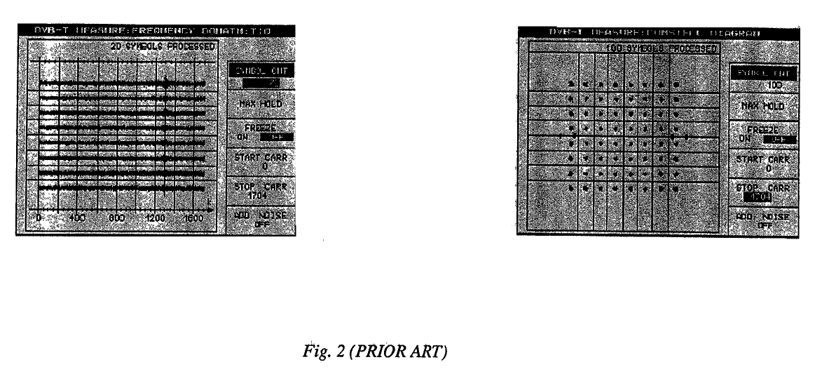

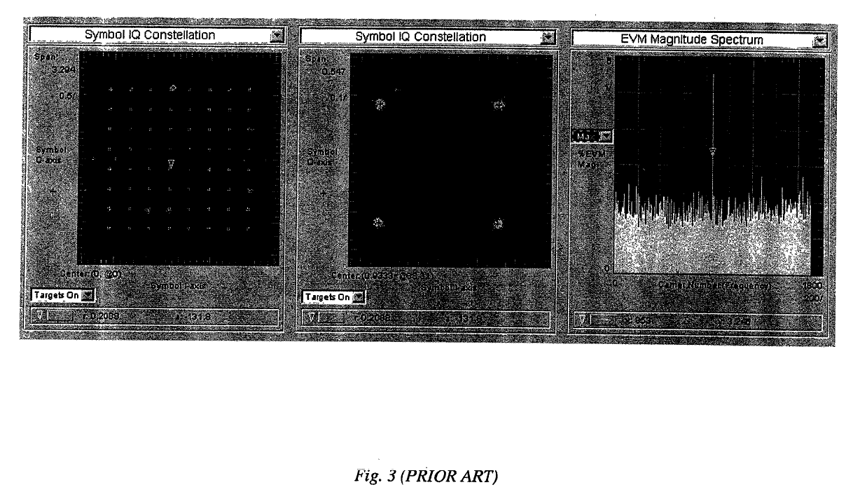

The deviation from ideal is shown in the well-known constellation plot. These are shown in the right pane of FIG. 2, and the left and center panes of FIG. 3. The right pane of FIG. 2 and the left pane of FIG. 3 both show constellations of multiple subcarriers. The central pane of FIG. 3 shows the constellation for a single subcarrier. Differences between an ideal signal and the actual signal as tracked over multiple symbol times display as a spread around the desired point.

Given the actual symbols for each subcarrier, the ideal symbol values (x+iy) are calculated 160. Ideal symbol values are subtracted 170 from actual symbol values 150 forming a set of error values for each subcarrier.

This set of error values for each subcarrier may be summed, over subcarriers and over symbols, for example by forming a root-mean-square sum, to give an overall scalar error vector magnitude.

This overall process is repeated for each successive symbol time. Each successive FFT is considered a symbol time, generating M symbols, one per subcarrier.

While such a scalar value may provide a useful go/no-go test value, it gives little insight into performance over multiple subcarriers. Constellation plots, with single and multiple subcarriers, give an indication of performance, but do not show trends over multiple subcarriers or multiple symbols.

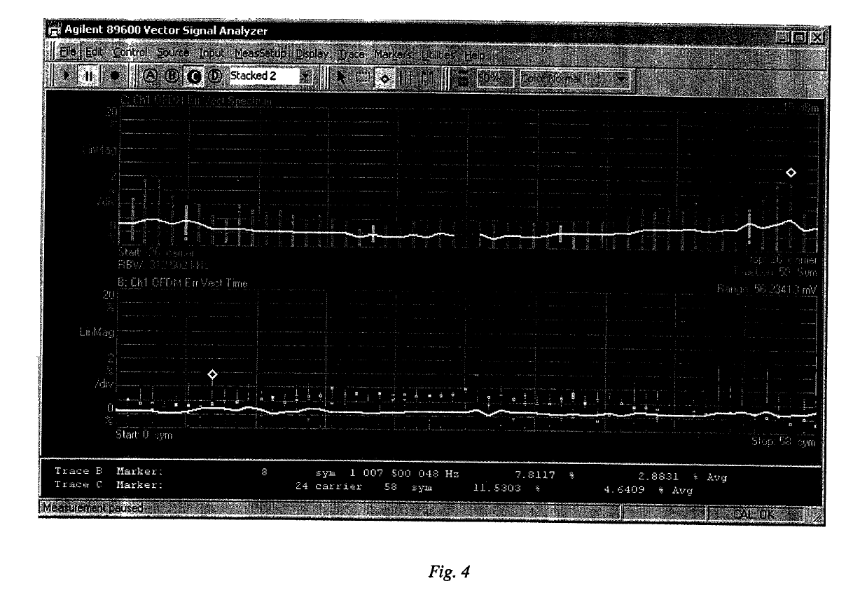

According to the present invention, as shown in FIG. 4, two error vector plots are displayed from calculated error data. For each subcarrier, and over a set of symbol times, error data is calculated. This error data may be retained so that calculations such as peak, average, and RMS values may be calculated at one time, or these values may be calculated and stored as each symbol is processed.

The top plot of FIG. 4 shows the error vector spectrum in which the x-axis is the subcarrier (number or frequency). In this plot, the magnitude of each error is plotted against the subcarrier (frequency or number). This creates a display resembling a bar graph, however, the bars are made up of multiple individual error points collected over multiple symbols. The line connecting different subcarriers shows the root-mean-square (RMS) value of errors as a function of carrier. This plot shows performance over all subcarriers, in this case, showing errors increasing as the distance from the center frequency increases.

In the top plot of FIG. 4, labeled “C: Ch1 OFDM Err Vect Spectrum,” unique subcarriers, in this example the pilot carriers used in IEEE 802.11a, are shown in a different color. Since the center subcarrier is unused, no bar is shown in the center of the display. A marker may be used to interrogate information about a single subcarrier at a given symbol time. In the example shown in the top plot of FIG. 4, the marker, in this case a white square, selects a particular subcarrier. Information on this subcarrier, including individual symbol errors and average error, is shown at the bottom of the plot, in this case showing subcarrier 24 has a peak error of 11.5303% and an (RMS) average error of 4.6409% at symbol time 58.

The bottom plot in FIG. 4 shows an error time plot. This plot is similar to the error spectrum plot. In this lower plot, the x-axis is time, in this case, symbol times. At each symbol time, the y-axis bar is the error magnitude over all subcarriers. The line connecting the vertical bars is the RMS over all subcarriers at each point in time. This specific plot shows an 802.11a signal with 52 subcarriers over 58 symbol intervals.

This bottom plot, labeled “B: Ch1 OFDM Err Vect Time” shows errors over multiple symbol times.

The two plots may be displayed and viewed separately, or they may be displayed together. Marker information may be coupled together so that the same time-frequency point may be observed in both plots.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. In a system for displaying errors in a multiple carrier modulation format having a plurality of subcarriers, the process of:
calculating an error value for each subcarrier over a plurality of symbol times, and
displaying a graph where one axis is the subcarrier, and for each subcarrier displaying in another axis the error values for that subcarrier.

2. The process of claim 1 where the displayed graph also includes an indication of the average error for each subcarrier.

3. The process of claim 2 where the average error for each subcarrier is the root mean square.

4. The process of claim 2 where the average error for each subcarrier is connected to show a trend between subcarriers.

5. The process of claim 2 where unused subcarriers are not displayed.

6. The process of claim 2 where the multiple carrier modulation format is the IEEE 802.11a modulation format.

7. The process of claim 2 where specific subcarriers are shown in a differentiated fashion from other subcarriers.

8. The process of claim 7 where specific subcarriers are shown in a different color from other subcarriers.

9. The process of claim 6 where the 802.11a pilot carriers are shown in a differentiated fashion from other subcarriers.

10. The process of claim 9 where the 802.11a pilot carriers are shown in a different color from other subcarriers.

11. In a system for displaying errors in a multiple carrier modulation format having a plurality of subcarriers, the process of:
calculating an error value for each subcarrier over a plurality of symbol times, and
displaying a graph where one axis is symbol times, and for each symbol time displaying on the other axis errors over all subcarriers for that symbol time.

12. The process of claim 11 where the displayed graph also includes an indication of the average error for each symbol time.

13. The process of claim 12 where the average error is the root mean square.

14. The process of claim 12 where the average error for each symbol time is connected to show a trend over symbol times.

15. In a system for displaying errors in a multiple carrier modulation format having a plurality of subcarriers, the process of:
calculating an error value for each subcarrier over a plurality of symbol times,
displaying a first graph where one axis is the subcarrier, and for each subcarrier displaying in another axis the error values for that subcarrier, and
displaying a second graph where one axis is symbol times, and for each symbol time displaying on the other axis errors over all subcarriers for that symbol time.

16. The process of claim 15 where the first graph also includes an indication of average error for each subcarrier, and the second graph includes an indication of average error for each symbol time.

17. The process of claim 17 where the average error displayed in the first and second graphs is the root mean square.

18. The process of claim 16 where the average error for each subcarrier in the first graph is connected to show a trend between subcarriers, and the average error for each symbol time in the second graph is connected to show a trend over symbol times.

19. The process of claim 16 where the multiple carrier modulation format is IEEE 802.11a.
